(19) United States
(12) Patent Application Publication
(10) Pub. No.: US 2021/0278899 A1
(43) Pub. Date: Sep. 9, 2021

(54) DISPLAY CONTROL METHOD, DISPLAY CONTROL SYSTEM AND WEARABLE DEVICE

(71) Applicant: Coretronic Reality Incorporation, Hsinchu County (TW)

(72) Inventors: Yi-Fa Wang, Hsin-Chu (TW); Ping-Chen Ma, Hsin-Chu (TW); Shih-Min Wu, Hsin-Chu (TW)

(73) Assignee: Coretronic Reality Incorporation, Hsinchu County (TW)

(21) Appl. No.: 17/191,714

(22) Filed: Mar. 4, 2021

(30) Foreign Application Priority Data
Mar. 6, 2020 (CN) 202010149722.9

(51) Int. Cl. G06F 3/01; G06F 1/16; G06F 3/0481; G06F 3/0346

(52) U.S. Cl. CPC G06F 3/014; G06F 1/163; G09G 2370/06; G06F 3/0346; G06F 3/04817

(57) ABSTRACT

A display control method, a display control system, and a wearable device are provided. The display control system includes a display device and a wearable device. The wearable device includes a detector and a microcontroller. The display control method is suitable for the display control system. The method includes: establishing a connection with the display device by the wearable device; in response to the wearable device detecting a display activation operation, enabling a display function of the display device through the connection by the wearable device; and in response to the wearable device detecting a communication activation operation, activating a communication mode between the wearable device and the display device by the wearable device. By using the display control system and method provided by the invention, the user can remotely operate the display device under relatively unrestricted conditions, and that operation is conveniently performed.

### CROSS-REFERENCE TO RELATED APPLICATION

This application claims the priority benefit of China application serial no. 202010149722.9, filed on Mar. 6, 2020. The entirety of the above-mentioned patent application is hereby incorporated by reference herein and made a part of this specification.

### BACKGROUND

### 1. Technical Field

The invention relates to a display control method, a display control system, and a wearable device.

### 2. Description of Related Art

In the related art, if a user wants to remotely operate an augmented reality (AR) device or a smart device (such as a mobile phone), the user is required to wear a special wearable device (such as AR glasses). A lens of the wearable device is then used to capture and recognize gestures performed by the user. However, in some situations, this manner may be neither secure nor convenient.

Taking the AR glasses as an example, in the above manner, the user needs to move his hand to the image capturing range of the lens of the AR glasses, so that the AR glasses can recognize the gesture based on the captured hand image. However, the user must present gestures that are easy for the AR glasses to perform image recognition, but the fineness is quite limited, so it is inconvenient.

For those skilled in the art, a technical solution that allows the user to remotely and conveniently operate an AR device and/or a smart device is an important issue.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention were acknowledged by a person of ordinary skill in the art.

### SUMMARY

The invention provides a display control method, a display control system, and a wearable device, through which a user can remotely and conveniently operate a display device such as an AR device or a smart device.

The embodiments of the invention provide a display control method suitable for a display control system including a display device and a wearable device. The display control method includes the following steps. A connection with the display device is established by the wearable device. In response to the wearable device detecting a display activation operation, a display function of the display device is enabled through the connection by the wearable device. In response to the wearable device detecting a communication activation operation, a communication mode is activated between the wearable device and the display device by the wearable device.

The embodiments of the invention provide a display control system including a display device and a wearable device. The wearable device is configured to establish a connection with the display device by the wearable device. In response to the wearable device detecting a display activation operation, the wearable device enables a display function of the display device through the connection. In response to the wearable device detecting a communication activation operation, the wearable device activates a communication mode between the wearable device and the display device.

The embodiments of the invention provide a wearable device including at least one detector and a microcontroller. The detector is electrically connected to the microcontroller, and the microcontroller is configured to establish a connection with a display device by the wearable device. The wearable device detects a display activation operation and enables a display function of the display device through the connection. The wearable device detects a communication activation operation and activates a communication mode between the wearable device and the display device.

Based on the above, the display control system and method of the invention allow a user to input different operations (such as gestures) by using the wearable device, so that the wearable device establishes the connection with the display device, enables the display function of the display device, and enables the communication mode between the wearable device and the display device. In addition, the user can easily activate/terminate the above communication mode at any time through different gestures. Thus, the invention allows the user to remotely operate the display device under relatively unrestricted conditions, so that operation is performed conveniently. The invention also allows the user to input different operations (such as gestures) to control the electronic device with the wearable device, so that the electronic device makes the display device synchronously present the picture on the electronic device through the miracast connection with the display device, thereby forming an intuitive, convenient, and safe operation mechanism.

Other objectives, features and advantages of the invention will be further understood from the further technological features disclosed by the embodiments of the invention wherein there are shown and described exemplary embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a display control system according to an embodiment of the invention.

FIG. 2 is a flow chart of a display control method according to an embodiment of the invention.

FIG. 3 is a schematic diagram of a display control system according to another embodiment of the invention.

### DESCRIPTION OF THE EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

The foregoing and other technical content, features, and effects of the invention can be clearly presented below in detailed description with reference to preferred embodiments of the accompanying drawings. The directional terms mentioned in the embodiments below, like “above”, “below”, “left”, “right”, “front”, or “back”, refer to the directions in the accompanying drawings. Therefore, the directional terms are only used for illustration instead of limiting the invention.

Exemplary embodiments of the present invention are described in detail, and examples of the exemplary embodiments are shown in the accompanying drawings. Whenever possible, the same element symbols are used in the drawings and descriptions to indicate the same or similar parts.

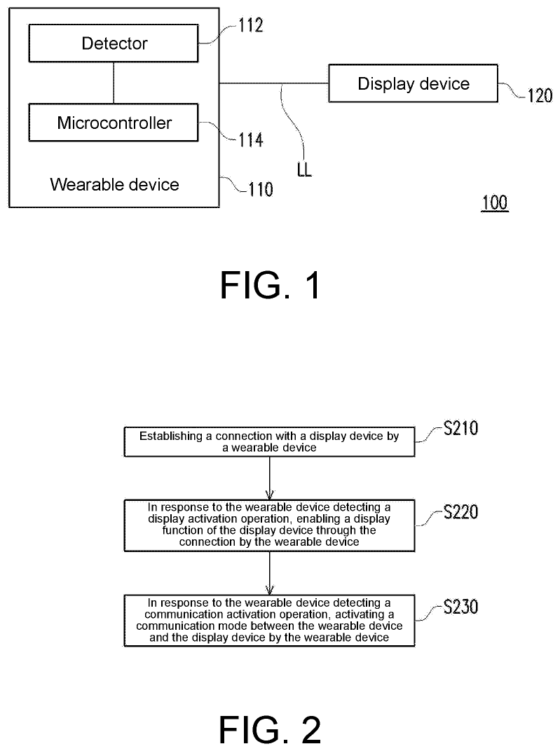

Please refer to FIG. 1, which is a schematic diagram of a display control system according to an embodiment of the invention. As shown in FIG. 1, the display control system 100 includes a wearable device 110 and a display device 120. In some embodiments, the wearable device 110 includes, for example, any device that can be worn on a body part of a user, such as a glove. For example, the wearable device 110 may include a detector 112 and a microcontroller 114. In the present embodiment, the detector 112 is, for example, a multi-axis sensor (for example, a nine-axis sensor) and can be configured to detect a movement of a body part of a user and generate dynamic data accordingly. The microcontroller 114 may be electrically connected to the detector 112 and may recognize an operation provided by the body part of the user based on the dynamic data provided by the detector 112 to generate recognition data (for example, hand-waving or a movement of a finger).

In an embodiment, the wearable device 110 may further include a communication module (for example, a Bluetooth module or a Wi-Fi , Zigbee or other communication modules) (not shown) electrically connected to the microcontroller 114, which may be controlled by the microcontroller 114 to establish a connection with the display device 120 and configured to send the recognition data generated by the microcontroller 114 to the display device 120.

In different embodiments, the display device 120 is, for example, a projector, a head-up display, AR glasses, or other devices having a display function, but is not limited thereto.

In an embodiment of the invention, the wearable device 110 and the display device 120 can cooperate to implement the display control method provided by the invention, so that the wearable device 110 can remotely control the display device 120. The details are described below.

Please refer to FIG. 2, which is a flow chart of a display control method according to an embodiment of the invention. The method of the present embodiment may be performed by the display control system 100 of FIG. 1. The details of steps of FIG. 2 are described below with reference to the content of FIG. 1. In addition, in order to facilitate understanding of the concept of the invention, an electronic glove that can be worn on a hand of a user is taken as an example of the wearable device 110 below. The electronic glove can be configured to detect gestures presented/input by the hand of the user. In this case, the detector 112 may be, for example, disposed at a fingertip of the electronic glove to detect gestures such as hand-waving, pinching, clicking, grasping, and swiping presented by the finger of the user, but the invention is not limited thereto.

In step S210, the user triggers a switch of the wearable device 110, so that the wearable device 110 can establish a connection LL with the display device 120. In the embodiments of the invention, the above connection LL is, for example, a Bluetooth connection, but is not limited thereto. That is, the microcontroller 114 may control the communication module of the wearable device 110 to communicate with a communication module (not shown) on the display device 120 to establish the connection LL.

In an embodiment, the display function of the display device 120 may be predetermined to be disabled. In other words, the display device 120 is predetermined not to display a picture or an image. The wearable device 110 of the invention may enable the display function of the display device 120 through step S220 below, that is, start the display function of the display device 120.

In step S220, a body part (for example, a hand) of the user may wear the wearable device 110. In response to the wearable device 110 detecting a display activation operation, the wearable device 110 enables the display function of the display device 120 through the connection LL. In an embodiment, the display activation operation may be performed, for example, by a hand. For example, the hand of the user may perform a first gesture (finger flicking), and the first gesture may correspond to the display activation operation. In this case, based on dynamic data provided by the detector 112, the microcontroller 114 may recognize the first gesture. When it is determined that the display activation operation is detected, the microcontroller 114 may enable the display function of the display device 120 through the connection LL. It is worth mentioning that the microcontroller 114 is, for example, a central processing unit (CPU), or other programmable general purpose or special purpose microprocessors, digital signal processors (DSPs), programmable controllers, application specific integrated circuits (ASICs), programmable logic devices (PLDs) or other similar devices or a combination of these devices, but is not limited thereto. The microcontroller 114 further includes a storage device for storing a plurality of predetermined information corresponding to a plurality of dynamic data. Based on the dynamic data provided by the detector 112, the microcontroller 114 may recognize the gesture by a comparison manner. The storage device is, for example, a removable random access memory (RAM), a read-only memory (ROM), a flash memory, or a similar element or a combination of the foregoing elements.

In an embodiment, a specific application may be installed on the display device 120 and used for the wearable device 110 to control the display device 120. In this case, the wearable device 110 may, for example, enable the display function of the display device 120 by sending a display activation signal to the display device 120. Correspondingly, after a specific application of the display device 120 receives a display enable signal, a picture or image is displayed accordingly. In this embodiment, the display activation signal may correspond to the display activation operation.

In an embodiment, after the display function of the display device 120 is enabled, the display device 120 may display a first icon accordingly to indicate that the display function of the display device 120 is started.

For example, taking a projector as an example of the display device 120, after the display function of the projector is enabled, the projector may project or display an on-screen display (OSD) as the first icon, but the invention is not limited thereto.

In step S230, in response to the wearable device 110 detecting a communication activation operation, the wearable device 110 activates a communication mode between the wearable device 110 and the display device 120.

In an embodiment, the communication activation operation may be performed, for example, by a hand. For example, the hand of the user may perform a second gesture, and the second gesture may correspond to the communication activation operation. In this case, based on dynamic data provided by the detector 112, the microcontroller 114 may recognize the second gesture. When it is determined that the communication activation operation is detected, the microcontroller 114 may start the communication mode between the wearable device 110 and the display device 120 through the connection LL.

In an embodiment, after the communication mode between the wearable device 110 and the display device 120 is activated, the display device 120 may display a communication icon accordingly to indicate that the communication mode is activated. For example, taking a projector as an example of the display device 120, after the communication mode is started, the projector may project or display a finger icon or keyboard icon as the communication icon within a predetermined display range or in a predetermined display position, so that the user knows that the communication mode is activated.

In an embodiment, after the communication mode is activated, the wearable device 110 may continuously performs an operation of detecting the body part (that is, the hand) and further control the display device 120 accordingly. For example, the display device 120 may include, for example, a display screen to display an image. In the communication mode, when the hand of the user moves in a three-dimensional space, the communication icon (for example, the finger icon) displayed on the display device 120 may move (for example, swipe) in the display screen of the display device 120 accordingly.

In the communication mode, in response to different postures of the body part wearing the wearable device 110, the communication icon may also present different patterns on the display screen of the display device 120 to reflect the posture change of the body part of the user.

In the communication mode, when the hand of the user performs a trigger gesture, the microcontroller 114 may trigger a specific function of the display device 120. For example, the display screen of the display device 120 may display a plurality of application icons, and these application icons may correspond to a plurality of functions of the display device 120, for example, a correction function. When the user wants to start the correction function of the display device 120 (for example, the projector), the user may move the hand, so as to correspondingly move the communication icon to the application icon (for example, an on-screen button) corresponding to the correction function, and perform the trigger gesture, thereby activating the correction function of the projector. In other words, the user can start the correction function without contacting the projector, but the invention is not limited thereto.

In some embodiments, after the communication mode is activated, the wearable device 110 may continuously perform detection. When the wearable device 110 detects a communication termination operation, the wearable device 110 may deactivate the communication mode.

In an embodiment, the communication termination operation may be performed, for example, by the user with the body part (that is, the hand) wearing the wearable device 110. For example, the hand of the user may perform a third gesture. In this case, based on dynamic data provided by the detector 112, the microcontroller 114 may recognize the third gesture. When it is determined that the communication termination operation is detected, the microcontroller 114 may deactivate the communication mode between the wearable device 110 and the display device 120 through the connection LL.

In an embodiment, the display device 120 may stop displaying the above communication icon to indicate that the communication mode is stopped. Further, after the communication mode is terminated, the wearable device 110 may stop performing the operation of detecting the body part. In this case, the user temporarily cannot control the display device 120 by moving the body part (that is, the hand). In other embodiments, when the communication mode is terminated, the wearable device 110 may continuously perform detection, and when the wearable device 110 detects the communication activation operation (for example, the second gesture) and when it is determined that the communication activation operation is detected, step S230 is performed again to activate the communication mode between the wearable device 110 and the display device 120.

In addition, in an embodiment, the display device 120 has a predetermined display range. When the communication icon is moved outside the predetermined display range, it may be determined that a communication termination operation is detected, thereby deactivating the communication mode between the wearable device 110 and the display device 120.

In an embodiment, the wearable device 110 may detect a display deactivation operation, and in response to detecting the display deactivation operation, the wearable device 110 may disable the display function of the display device 120 through the connection LL. In a first embodiment, the display deactivation operation may be performed, for example, by a hand of a user. For example, the hand of the user may perform a fourth gesture, and the fourth gesture may correspond to the display deactivation operation. In this case, based on dynamic data provided by the detector 112, the microcontroller 114 may recognize the fourth gesture. When it is determined that the display deactivation operation is detected, the microcontroller 114 may deactivate the display function of the display device 120 through the connection LL.

As can be seen from the above, the invention allows the user to remotely and conveniently control the display device 120 through the wearable device 110. Besides, compared with the conventional image recognition method, the invention also allows the user to input gestures and other operations in a relatively unrestricted manner, for example, without moving the hand to an image capturing range of a camera.

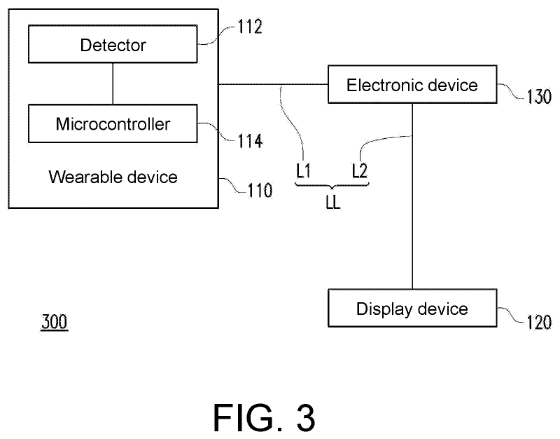

Please refer to FIG. 3, which is a schematic diagram of a display control system according to another embodiment of the invention. In the present embodiment, compared with the display control system 100 of FIG. 1, the display control system 300 of FIG. 3 further includes an electronic device 130. In some embodiments, the electronic device 130 is, for example, a smartphone, a tablet computer, or other similar devices, but is not limited thereto.

In the present embodiment, the wearable device 110, the display device 120 and the electronic device 130 may cooperate to implement the display control method of FIG. 2, so that the wearable device 110 can remotely control the display device 120. The details are described below.

First, in step S210, the wearable device 110 may establish a connection LL with the display device 120. It should be understood that, in the present embodiment, the connection LL may include a first connection L1 and a second connection L2 (for example, a wireless connection of Bluetooth or Wi-Fi). Specifically, in the present embodiment, the wearable device 110 may establish the first connection L1 with the electronic device 130, and the electronic device 130 may establish the second connection L2 with the display device 120. In an embodiment, after the first connection L1 is established, the wearable device 110 may control the electronic device 130. For example, when the wearable device 110 detects a connection establishment operation, the electronic device 130 may be triggered to establish the second connection L2 with the display device 120. In the present embodiment, the establishment of the first connection L1 and the second connection L2 may be performed, for example, by the user through the body part (that is, the hand) wearing the wearable device 110. For example, the hand of the user may perform a gesture corresponding to the connection establishment operation. In this case, based on dynamic data provided by the detector 112, the microcontroller 114 may recognize the gesture. When it is determined that the connection establishment operation is detected, the microcontroller 114 may trigger the electronic device 130 to establish the second connection L2 with the display device 120 through the first connection L1.

In the present embodiment, a specific application may be installed on the electronic device 130 and used for the wearable device 110 to control the electronic device 130.

In the present embodiment, after the second connection L2 is established, the electronic device 130 may display a connection successful icon (for example, an arrow icon or a text icon of “connection successful”) accordingly to indicate that the second connection L2 is established. For example, the second connection L2 is, for example, miracast connection, that is, the electronic device 130 may project the picture displayed on itself to the display device 120 in a miracast manner, so that the display device 120 displays the same picture, but the invention is not limited thereto.

In the present embodiment, the applications, display activation operation, communication activation operation, communication termination operation and display deactivation operation of the display device 120 and the electronic device 130 are similar to the embodiment of FIG. 1. For brevity, only the differences are described below. In this implementation, the wearable device 110 may respectively or sequentially send a display activation signal, a communication activation signal, a communication termination signal, and/or a display deactivation signal to the electronic device 130 through the first connection L1, and then respectively or sequentially enable the display function of the display device 120, activate the communication mode between the wearable device 110 and the display device 120, deactivate the communication mode, and/or deactivate the display function of the display device 120 through the second connection L2.

For example, in the case where the second connection L2 is miracast connection, after the communication mode is activated, the display device 120 and the electronic device 130 may display the communication icon accordingly, and when the hand of the user moves in the three-dimensional space, the communication icon displayed on the display device 120 and the electronic device 130 may move accordingly.

For example, the display device 120 is AR glasses, and the electronic device 130 is a smartphone. When the communication mode is enabled, the smartphone (the electronic device 130) and the AR glasses (the display device 120) may display the communication icon, so that the user knows that the communication mode is entered. For another example, the display device 120 is a projector. When the communication mode is enabled, the smartphone (the electronic device 130) may display the communication icon, and the projector (the display device 120) may accordingly project the communication icon on a projection target (for example, a projection wall and a curtain), or the projector (the display device 120) may display the communication icon in a predetermined display position (for example, a display screen of the projector).

In the present embodiment, after entering the communication mode, if the user wants to take a picture or video, the user can move the hand to move the communication icon to a camera application on the electronic device 130 and enter a trigger gesture (for example, click), thereby starting the camera application of the electronic device 130. Further, through the second connection L2 (for example, miracast), the display device 120 may synchronously display the picture shot by the electronic device 130 for the user to watch accordingly. In other words, the user may remotely start the application of the electronic device 130, and the display device 120 may display the picture in synchronization with the electronic device 130, but the invention is not limited thereto.

More specifically, for example, the wearable device 110 is an electronic glove, the display device 120 is AR glasses or a head-up display in a car, and the electronic device 130 is a smartphone. When the user drives or stops at a red light, the hand of the user is on the steering wheel or brake lever. If the user wants to operate the smartphone (the electronic device 130), the hand of the user may perform the second gesture (the communication activation operation) to start the communication mode between the electronic glove (the wearable device 110) and the AR glasses (the display device 120), so that the AR glasses (the display device 120) and the smartphone (the electronic device 130) can display the pictures in a miracast manner, and thereby, the user can conveniently check the operation for the smartphone (the electronic device 130). In this process, since the user does not need to actually contact the electronic device 130, the placement position of the electronic device 130 is relatively unrestricted (for example, it may be placed out of the sight of the user). Further, when the user wants to continue driving, the display function of the AR glasses (the display device 120) may be deactivated remotely by using the electronic glove (the wearable device 110), so as to avoid affecting the sight.

Based on the above, the display control system and method of the invention allow the user to input different operations (such as gestures) by using the wearable device, so that the wearable device establishes the connection with the display device, enables the display function of the display device, and enables the communication modes between the wearable device and the display device. In addition, the user can easily activate/deactivate the above communication modes at any time through different gestures. Thus, the invention allows the user to remotely operate the display device under relatively unrestricted conditions, thereby enhancing the convenience in operation. The invention can also allow the user to input different operations (such as gestures) to control the electronic device with the wearable device, so that the electronic device makes the display device synchronously present the picture on the electronic device through the miracast connection with the display device, so that an intuitive, convenient, and safe operation mechanism is formed.

The foregoing descriptions are merely preferred embodiments of the invention, and are not intended to limit the scope of the invention. Any simple equivalent changes and modifications made to the claims or the specification shall still fall within the scope of the invention. In addition, a solution of any embodiment or claim of the invention does not need to achieve all the objectives or advantages or features disclosed by the invention. In addition, the abstract and title are only used to assist in searching for patent documents, and are not intended to limit the scope of rights of the invention. In addition, the terms “first”, “second”, and the like mentioned in this specification or the claims are used only to name elements or to distinguish between different embodiments or ranges, but are not intended to define the upper or lower limit of the number of elements.

The foregoing description of the exemplary embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be configured to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A display control method suitable for a display control system comprising a display device and a wearable device, wherein the display control method comprises:
establishing a connection with the display device by the wearable device;
in response to the wearable device detecting a display activation operation, enabling a display function of the display device through the connection by the wearable device; and
in response to the wearable device detecting a communication activation operation, activating a communication mode between the wearable device and the display device by the wearable device.

2. The display control method according to claim 1, wherein the wearable device is worn on a body part of a wearer, wherein the display control method further comprises:
an operation of detecting the body part by the wearable device after activating the communication mode.

3. The display control method according to claim 1, wherein the display control method further comprises:
after activating the communication mode, in response to the wearable device detecting a communication termination operation, deactivating the communication mode by the wearable device.

4. The display control method according to claim 3, wherein the display control method further comprises:
after deactivating the communication mode, in response to the wearable device detecting the communication activation operation again, activating the communication mode again by the wearable device.

5. The display control method according to claim 1, wherein the display control method further comprises:
in response to the wearable device detecting a display deactivation operation, disabling the display function of the display device through the connection by the wearable device.

6. The display control method according to claim 1, wherein the display control method further comprises:
after enabling the display function of the display device by the wearable device, displaying a first icon by the display device to indicate that the display function of the display device is started.

7. The display control method according to claim 2, wherein the display control method further comprises:
after activating the communication mode, displaying a communication icon by the display device to indicate that the communication mode is started.

8. The display control method according to claim 7, wherein the display device comprises a display screen, and the operation of detecting the body part by the wearable device comprises:
in response to a movement of the body part, the communication icon moves on the display screen of the display device; and
in response to different postures of the body part, the communication icon presents different patterns on the display screen of the display device.

9. The display control method according to claim 8, wherein the display screen of the display device further displays a plurality of application icons, the plurality of application icons correspond to a plurality of functions of the display device, and the movement and the postures of the body part are configured to control the plurality of functions.

10. The display control method according to claim 7, wherein the display device comprises a predetermined display range, and the display control method further comprises:
in response to the communication icon being moved outside the predetermined display range, deactivating the communication mode by the wearable device.

11. The display control method according to claim 1, wherein the connection comprises a first connection and a second connection, the display control system further comprises an electronic device, and establishing the connection with the display device by the wearable device comprises:
establishing the first connection between the wearable device and the electronic device; and
controlling the electronic device to establish the second connection with the display device by the wearable device.

12. The display control method according to claim 11, wherein controlling the electronic device to establish the second connection with the display device by the wearable device comprises:
in response to the wearable device detecting a connection establishment operation, triggering the electronic device to establish the second connection with the display device by the wearable device; and
after establishing the second connection, displaying a connection successful icon by the electronic device to indicate that the second connection is established.

13. The display control method according to claim 11, wherein enabling the display function of the display device through the connection by the wearable device comprises:
in response to the display activation operation, sending a display activation signal to the electronic device through the first connection by the wearable device; and
receiving the display activation signal by the electronic device and enabling the display function of the display device through the second connection.

14. The display control method according to claim 11, wherein activating the communication mode comprises:
in response to the communication activation operation, sending a communication activation signal to the electronic device through the first connection by the wearable device; and
receiving the communication activation signal by the electronic device and activating the communication mode through the second connection.

15. The display control method according to claim 11, wherein the second connection is miracast connection, and the display control method further comprises:
after activating the communication mode, displaying a communication icon by the electronic device to indicate that the communication mode is started and projecting the communication icon to a projection target through the second connection by the display device.

16. The display control method according to claim 15, wherein the electronic device comprises a predetermined display range, and the display control method further comprises:
in response to the communication icon being moved outside the predetermined display range, deactivating the communication mode by the wearable device.

17. A display control system, wherein the display control system comprises a display device and a wearable device:
wherein the wearable device is configured to:
establish a connection with the display device by the wearable device;
in response to the wearable device detecting a display activation operation, enable a display function of the display device through the connection by the wearable device; and
in response to the wearable device detecting a communication activation operation, activate a communication mode between the wearable device and the display device by the wearable device.

18. The display control system according to claim 17, wherein the wearable device is worn on a body part of a wearer, and after activating the communication mode, the wearable device performs an operation of detecting the body part, wherein after activating the communication mode, the display device displays a communication icon to indicate that the communication mode is started.

19. The display control system according to claim 18, wherein the display device comprises a display screen, wherein in response to a movement of the body part, the communication icon moves on the display screen of the display device, and in response to different postures of the body part, the communication icon presents different patterns on the display screen of the display device.

20. The display control system according to claim 17, wherein the display device comprises a predetermined display range, and in response to the communication icon being moved outside the predetermined display range, the wearable device deactivates the communication mode.

21. The display control system according to claim 17, wherein after activating the communication mode, in response to the wearable device detecting a communication termination operation, the wearable device deactivates the communication mode.

22. The display control system according to claim 17, wherein in response to the wearable device detecting a display deactivation operation, the wearable device disables the display function of the display device through the connection.

23. The display control system according to claim 17, wherein after enabling the display function of the display device by the wearable device, the display device displays a first icon to indicate that the display function of the display device is started.

24. The display control system according to claim 17, wherein the connection comprises a first connection and a second connection, the display control system further comprises an electronic device, and establishing the connection with the display device by the wearable device comprises: establishing the first connection between the wearable device and the electronic device; and controlling the electronic device to establish the second connection with the display device by the wearable device.

25. The display control system according to claim 24, wherein the second connection is miracast connection, and after activating the communication mode, the electronic device displays a communication icon to indicate that the communication mode is started, and the display device projects the communication icon to a projection target through the second connection.

26. The display control system according to claim 17, wherein the wearable device is an electronic glove comprising a multi-axis sensor, and the display device comprises one of a projector, a head-up display, and a smartphone.

27. A wearable device, wherein the wearable device comprises: at least one detector and a microcontroller;
wherein the at least one detector is electrically connected to the microcontroller, and the microcontroller is configured to:
establish a connection with a display device;
detect a display activation operation and enable a display function of the display device through the connection; and
detect a communication activation operation and activate a communication mode between the wearable device and the display device.

28. The wearable device according to claim 27, wherein the wearable device is worn on a body part of a wearer, and after activating the communication mode, the wearable device performs an operation of detecting the body part, wherein after activating the communication mode, the display device displays a communication icon to indicate that the communication mode is started.

29. The wearable device according to claim 28, wherein the display device comprises a display screen, wherein in response to a movement of the body part, the communication icon moves on the display screen of the display device, and in response to different postures of the body part, the communication icon presents different patterns on the display screen of the display device.

30. The wearable device according to claim 27, wherein the display device comprises a predetermined display range, and in response to the communication icon being moved outside the predetermined display range, the wearable device deactivates the communication mode.

31. The wearable device according to claim 27, wherein after activating the communication mode, in response to the wearable device detecting a communication termination operation, the wearable device deactivates the communication mode.

32. The wearable device according to claim 27, wherein in response to the wearable device detecting a display deactivation operation, the wearable device disables the display function of the display device through the connection.

33. The wearable device according to claim 27, wherein the wearable device is an electronic glove comprising a multi-axis sensor, and the display device comprises one of a projector, a head-up display, and a smartphone.
